(19) United States
(12) Patent Application Publication
(10) Pub. No.: US 2005/0012239 A1
(43) Pub. Date: Jan. 20, 2005

(54) Solution casting apparatus and process, cellulose acylate film, polarizing plate, and image display device

(75) Inventor: Hiroshi Nakashima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/892,329

(22) Filed: Jul. 16, 2004

(30) Foreign Application Priority Data
Jul. 17, 2003 (JP) 2003-198554

(51) Int. Cl. B29C 39/14

(52) U.S. Cl. 264/216; 425/224; 425/447; 425/363

(57) ABSTRACT

A solution casting apparatus includes a band-shaped support for casting of dope containing cellulose triacetate thereon. So polymer film of cellulose triacetate is formed. Plural rotatable transport rollers support the polymer film stripped from the band-shaped support. A tentering device stretches the polymer film. The transport rollers are provided with a suction device for drawing nearer the polymer film by suction.

### BACKGROUND OF THE INVENTION

1. Field of the Invention

The present invention relates to a solution casting apparatus and process, cellulose acylate film, polarizing plate, and image display device. More particularly, the present invention relates to a solution casting apparatus and process capable of forming polymer film with a small thickness with high quality by stabilized operation, and cellulose acylate film, polarizing plate, and image display device.

2. Description Related to the Prior Art

Solution casting is known in the industrial field of plastic material, to produce polymer film. Dope or solution of polymer is supplied, which a casting die such as extruding die ejects and casts to a support. Cast film on the surface of the support comes to have self-supporting properties, and is stripped from the support to become the polymer film.

In combination with the solution casting, a drying step after the stripping step uses a tentering device. Prior to the final drying operation with drying rollers, the tentering device stretches the polymer film in regulating its film width for the purpose of improving a flat state, mechanical strength, and optical performance. JP-A 62-115035 discloses the use of the tentering device typically in combination with casting at high speed, and with the polymer film of which a solvent containing amount is high after stripping from the support. The tentering device can be used with remarkable effects.

The polymer film stripped from the support is transported to the tentering device. A transfer section 100 of the polymer film downstream from the support according to the prior art is illustrated in FIG. 5. An example of the support is a band-shaped support 101. A backup drum 102 rotates to move the band-shaped support 101 continuously. Plural transport rollers 106a, 106b and 106c are arranged from the band-shaped support 101 to a tentering device 105. The number of the transport rollers 106a-106c may be changeable, and can be two, or four or more. Cast film 110a on the band-shaped support 101 is stripped as polymer film 110b with self-supporting properties. The polymer film 10b is contacted on the transport roller 106a positioned upstream in the transfer section 100. Rotation of the transport roller 106a strips the polymer film 110b continuously. If the transport roller 106a is a free type, the polymer film 110b is caused to receive tension for continuous stripping. The transport rollers 106a-106c are either one of a film driving type or a free type rotated by the polymer film, and support the polymer film 110b which is transported. Thus, the polymer film moves through the transfer section 100 to the tentering device 105.

In the transfer section 100, the polymer film 110b is likely to have bends or folds of the selvedge portions, and wrinkles and other deformed shapes, and an unwanted stuck shape of the film surfaces, or curls of the edges. Those problems consist in failure in the transport in the transfer section 100, and also in failure in the surface quality of the polymer film 110b.

If the casting speed is set specifically high, and an amount of the solvent in the polymer film 110b is high, then the failure in the transport of surface quality is likely to occur. This is because rigidity of the polymer film 110b containing much solvent is low. Furthermore, there is a remarkable difference in the solvent containing amount between the stripped surface and the back surface of the polymer film. When curls occur in selvedges, curls extend in the transfer section, and become more hard to handle. Also, if the polymer film 110b has a specifically great width, the failure in the transport or surface quality is very likely to occur.

Various ideas are suggested for suppressing failure in the surface quality in the transfer section 100. JP-A 2001-277267 discloses a non-contact transporting device by blowing air to a back surface of the polymer film reverse to a stripped surface stripped from the support. Also, JP-A 11-090942 discloses suppression of curls of the polymer film. After the stripping, curls formed in the selvedges of the polymer film are slitted away in the transfer section 100. Then a decurling device positioned upstream from the tentering device decurls the slitted polymer film. Furthermore, U.S. Pat. No. 6,582,645 (corresponding to JP-A 2001-198933) discloses a use of a first roller for contacting a stripped surface immediately after stripping of the polymer film from the support, and a second roller for contacting a back surface reverse to the stripped surface in a position downstream directly from the first roller.

Drying in the tentering device 105 is necessitated for ensuring a flat state, mechanical strength, optical performance of the polymer film 110b, and preventing deformation of the polymer film 110b. Especially if the proportion of the solvent containing amount in the polymer film 110b immediately upon stripping from the support is high, the stretching and drying in the tentering device 105 is desirable. A further use of the tentering device 105 is to adjust, improve and control the optical performance of the polymer film 110b. So various purposes of the tentering device 105 requires efficiency, precision and high quality of handling the polymer film 110b upon being stripped.

None of the above-mentioned prior techniques is very effective in solving difficult problems of wrinkles, streaks or curls of the selvedges. If the polymer film to be produced has a specially small thickness, the prior techniques are not effective. For example, the idea of JP-A 2001-277267 has a problem in that the polymer film comes in unwanted contact with the transporting mechanism if floating of the polymer film is not very large. The unwanted contact will cause scratch the film surface, to result in failure in the surface quality.

The suggested technique in JP-A 11-090942 is not effective to suppressing failure in the surface quality and failure in the transport, because slitting the curled portions does not eliminate such failure. The polymer film in the transfer section has very low rigidity due to a high amount of solvent, and is technically difficult to slit. When inert gas is filled in a space of the transfer section as atmosphere, there is a problem in high cost for maintenance, for example exchange and adjustment of slitting blades, handling of slitted dust and the like.

U.S. Pat. No. 6,582,645 (corresponding to JP-A 2001-198933) may be effective in preventing failure in the surface quality. However, if a target thickness of the polymer film to be produced is as small as 100 microns, the idea disclosed in the document is difficult to practice with high reliability.

### SUMMARY OF THE INVENTION

In view of the foregoing problems, an object of the present invention is to provide a solution casting apparatus and process capable of forming polymer film with a small thickness with high quality by stabilized operation, and cellulose acylate film, polarizing plate, and image display device.

In order to achieve the above and other objects and advantages of this invention, a solution casting apparatus includes a support for casting of dope containing polymer thereon, whereby polymer film is formed. Plural rotatable rollers support the polymer film stripped from the support. A tentering device stretches the polymer film. The plural rotatable rollers are provided with a suction device for drawing nearer the polymer film by suction.

The plural rollers are constituted by at least one roller set each one of which includes at least two rollers. The suction device effects suction through a space between rollers included in respectively the at least one roller set.

The at least one roller set contacts a back surface of the polymer film opposite to a stripped surface thereof stripped from the support.

In one aspect of the invention, a solution casting process is provided. Dope containing polymer is cast on a support, so as to strip polymer film formed of the dope from the support. The polymer film is transported on rollers, so as to stretch the polymer film in a tentering device. The plural rollers are constituted by at least one roller set each one of which includes at least two rollers, and are provided with a suction device for suction through a space between rollers included in respectively the roller set. The polymer film is drawn nearer by suction of the suction device.

The polymer film is stripped from the support at a speed equal to or more than 45 m/min.

The polymer film has a width equal to or more than 1,400 mm and equal or less than 1,800 mm.

The polymer film is formed at a thickness equal to or more than 15 microns and equal to or less than 100 microns as viewed when dried.

The at least one roller set comprises first to Nth roller sets arranged in a transporting direction of the polymer film. The plural rollers further include a single rear roller, positioned upstream from the first roller set, opposed to the support, for stripping the polymer film therefrom.

The plural rollers further include a single front roller positioned between the Nth roller set and the tentering device.

The polymer is cellulose acylate.

In a preferred embodiment, the suction device includes a duct, having an intake opening directed to the surface of the polymer film. A fan or blower exhausts gas entered through the intake opening to an outside of the duct.

The suction device being at least one comprises plural suction devices associated with respectively the plural roller sets. Furthermore, a suction controller controls the plural suction devices in a manner individual from one another.

In another aspect of the invention, a cellulose acylate film produced by the solution casting process is provided.

In one aspect of the invention, a polarizing plate including a polarizer is provided. Protective films are overlaid on respectively surfaces of the polarizer. At least one of the protective films comprises the cellulose acylate film.

In still another aspect of the invention, an image display device including the cellulose acylate film is provided.

### BRIEF DESCRIPTION OF THE DRAWINGS

The above objects and advantages of the present invention will become more apparent from the following detailed description when read in connection with the accompanying drawings, in which:

FIG. 1 is an explanatory view in front elevation, illustrating a solution casting apparatus of the invention;

FIG. 2 is an explanatory view in front elevation, illustrating a transfer section in transporting polymer film in a solution casting apparatus;

FIG. 3 is an explanatory view in front elevation, illustrating another preferred transfer section with a single rear roller for stripping;

FIG. 4 is an explanatory view in front elevation, illustrating another preferred transfer section to which a single front roller is added; and

FIG. 5 is an explanatory view in front elevation, illustrating a transfer section of a solution casting apparatus of the prior art.

### DETAILED DESCRIPTION OF THE PREFERRED EMBODIMENT(S)OF THE PRESENT INVENTION

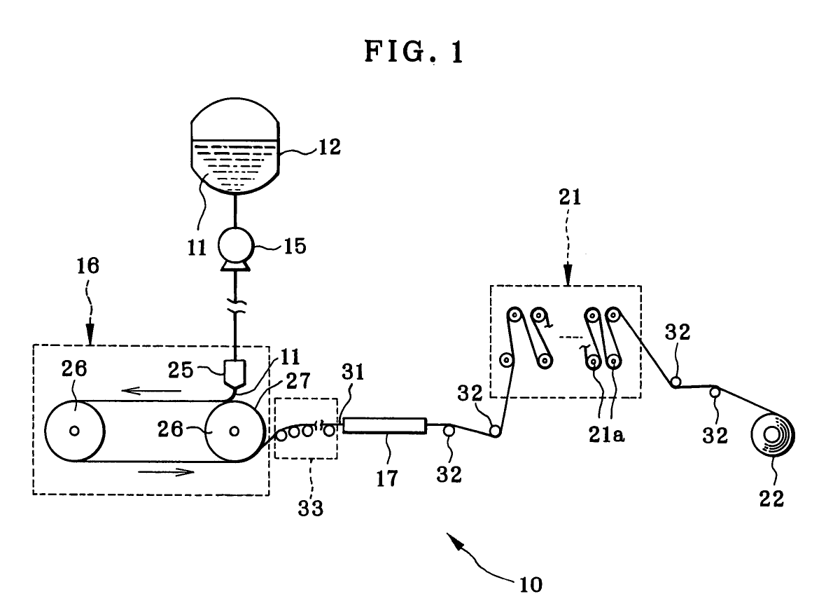

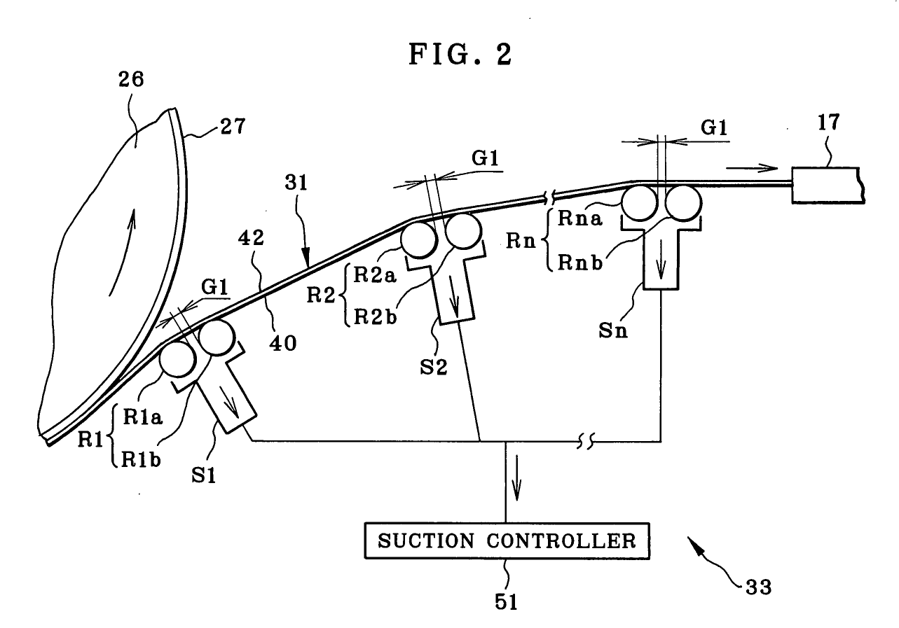

Preferred embodiments of the invention are hereinafter described by referring to the drawings. Note that the scope of the invention is not limited to specific features of the embodiments. In FIG. 1, a solution casting apparatus 10 of the invention is illustrated. The casting apparatus 10 includes a hopper 12 with a reservoir or tank, which is a source of dope 11 of solution to be supplied. Also, the casting apparatus 10 has a solution supply pump 15, a casting device 16, a tentering device 17, a dryer 21 of a roller type or festoon type, and a film winder 22. The casting device 16 includes an extruding die 25 as casting die, and a band-shaped support 27. A backup drum 26 supports a back surface of the band-shaped support 27, and rotate to turn the band-shaped support 27. As a product, polymer film 31 with self-supporting properties is stripped from the band-shaped support 27. Transport rollers 32 are arranged between the casting device 16 and the film winder 22. The number of the transport rollers 32 is not limited to that according to the arrangement in FIG. 2, but can be greater or smaller for the purpose of the suitable transport. The transport rollers 32 include two types, of which a film driving type is rotated by a driving mechanism to move the polymer film 31 directly, and a free type rotated by contact with the polymer film 31. Note that, in FIG. 1, only part of the transport rollers 32 is depicted in a simplified manner for good understanding. A term of a transfer section 33 is used to designate a section defined between the casting device 16 and the tentering device 17. Transport rollers used in the transfer section 33 will be described later in detail.

The dope 11 is caused to flow from the hopper 12 by the solution supply pump 15 to the extruding die 25, and cast on the band-shaped support 27. For the casting, various methods known in the art can be used. Examples of the casting include free falling extrusion from a die in a downward vertical direction, and extrusion in either a horizontal direction or an upward direction. Of course, a structure of the casting die can be determined suitably for the selected method. The band-shaped support 27 is turned continuously by the backup drum 26 rotating regularly and continuously. Thus, the dope 11 continues being cast. The dope 11 becomes a cast film on the band-shaped support 27, and gradually comes to have self-supporting properties by gelling, with which the polymer film 31 is stripped from the band-shaped support 27. The stripping operation is continued by rotation of a most upstream one of the rollers on which the polymer film 31 to be separated is wrapped. The polymer film 31 is sent through the transfer section 33 toward the tentering device 17.

In the tentering device 17, the polymer film 31 is stretched for orientation, and dried while regulated for its width. There are tenter clips (not shown) in the tentering device 17 for clamping longitudinal edges of the polymer film 31. A tenter path (not shown) in the tentering device 17 extends, on which the tenter clips are moved, so as to transport the polymer film 31. Note that pin clips may be used in place of the tenter clips. A controller (not shown) controls the tenter clips for automatic opening and closing movement, so as to hold and release the polymer film 31. The tenter clips move inside the tentering device 17, and upon reach to a releasing position near to an exit thereof, are shifted open for releasing the polymer film 31.

The polymer film 31 in the tentering device 17 is transported through the dryer 21 by the transport rollers 32 for either supporting or transporting. There are plural transport rollers 21a for supporting and transporting the polymer film 31. The dryer 21 dries the polymer film 31 sufficiently while transported on the transport rollers 21a. Then a cutter (not shown) or slitter slits away two selvedge portions from the polymer film 31. A middle portion of the polymer film 31 is obtained as a product, which is wound up in a roll form.

With reference to FIG. 2, a preferred embodiment is described in detail. In FIG. 2, the transfer section 33 is schematically illustrated. The transfer section 33 is provided with a plurality of pairs of rollers, each of the pairs constituting a roller set. Those are referred to as roller sets R1, R2, . . . , Rn in a downstream series, where n is a natural number. Any of the roller sets R1, R2, . . . , Rn contact a back surface 40 of the polymer film 31 and which is reverse to a stripped surface stripped from the band-shaped support.

In FIG. 2, each of roller sets R1, R2, . . . , Rn has one upstream roller and one downstream roller. Individual rollers which are upstream or downstream are referred to by addition of signs a and b as rollers R1a, R1b, R2a, R2b, . . . , Rna and Rnb. Any of the rollers R1a, R1b, R2a, R2b, . . . , Rna and Rnb has a length that is equal to or greater than a width of the polymer film 31. The roller sets R1, R2, . . . , Rn are provided with respectively the suction devices S1, S2, . . . , Sn. A suction controller 51 is connected with the suction devices S1, S2, . . . , Sn.

The suction devices S1, S2, . . . , Sn have a box shape, consist of a duct, and are provided on the roller sets R1, R2, . . . , Rn to position their intake opening (not shown) opposite to the rollers with respect to the polymer film. The intake opening is open for intake of air. In the roller sets R1, R2, . . . , Rn, there is a space or slot for a flow or suction of air between each of rear rollers R1a, R2a, . . . , Rna and an associated one of front rollers R1b, R2b, . . . , Rnb. Each of the suction devices S1, S2, . . . , Sn has a fan or blower, which the suction controller 51 controls for timing of suction and force of suction. For example, when the suction device S1 sucks air at the roller set R1, external air enters the suction device S1 through the space between the rollers R1a and R1b. Accordingly, the back surface of the polymer film 31 is kept sucked on to the rollers R1a and R1b, contacts them, and the polymer film 31 is transported by rotation of the rollers R1a and R1b. Also, the roller sets R2-Rn are controllable similarly to the roller set R1. Note that a size of the suction devices S1, S2, . . . , Sn in their longitudinal direction is equal to or greater than a width of the polymer film 31 to be transported. However, the suction devices S1, S2, . . . , Sn may have any suitable size, to which the scope of the present invention is not limited.

According to the prior art, the polymer film is wrapped on each of the transport rollers at a wrap angle of at least a value between one degree and ten degrees, so as to ensure force of friction sufficient for the frictional transport of the polymer film on the rollers in the transfer section. However, a length of the transporting the polymer film is enlarged, to increase wrinkles or streaks. In contrast to the prior art, the polymer film 31 handled according to the present invention is sucked and drawn in a direction toward the roller sets R1, R2, . . . , Rn during the transport of the polymer film 31 having a high proportion of the solvent being contained. It is unnecessary to have a wrap angle of the polymer film 31 on the rollers R1a, R1b, R2a, R2b, . . . , Rna and Rnb. The polymer film 31 can be kept flat while transported. Accordingly, occurrence of wrinkles or streaks due to the wrapping on the rollers can be suppressed. Also, the wrap angle can be reduced to nearly zero. A length of transport of the polymer film 31 can be small, to reduce the size of the entirety of the casting apparatus. Also, the suction can keep the transport stable. Selvedge portions of the polymer film 31 can be pressed against the rollers R1a, R1b, R2a, R2b, . . . , Rna and Rnb by the suction. This can prevent occurrence of curls in the selvedges.

Note that, in the transfer section 33, the solvent containing amount on the back surface 40 of the polymer film 31 is lower than a stripped surface 42 stripped from the band-shaped support 27. It is known that probability of occurrence of wrinkles, streaks and other failure of the polymer film 31 is low according to lowness of the solvent containing amount. Thus it is possible to suppress the failure of the surface quality of the polymer film 31 effectively by contacting of the rollers R1a, R1b, R2a, R2b, . . . , Rna and Rnb on the back surface 40.

In the present invention, a pressure of the suction is preferably kept in a level of 50-600 Pa for the purpose of suppressing failure in the transport of the polymer film 31 and failure in its surface quality. The pressure of the suction is more desirably 70-300 Pa. Should the pressure be higher than 600 Pa, force of the polymer film 31 toward the roller is so great that failure may occur in the transport. Also, the film surfaces of the polymer film 31 may be scratched in the transport. Should the pressure of the suction be lower than 50 Pa, the transport of the polymer film 31 is impossible because of force of handling the polymer film 31 is excessively small. This range of the pressure is specifically preferable for cellulose acylate film having the solvent containing ratio of 15-50 wt. % in the wet base percentage, and having a thickness of 30-200 microns in each transfer section. Note that this pressure of the suction is not limited to the above-mentioned value, because the pressure can be suitably determined according to various parameters, for example, relative weight and thickness of the polymer film 31 with solvent contained therein in the transfer section, tensile force applied to the polymer film 31 in the transporting direction. A term of the solvent containing amount (in wt. %) in the wet base percentage is used as a value obtained in a formula of:
[(W−Y)/W]×100
where W (grams) is a weight of the polymer film at the sampled time, and Y (grams) is a weight of a solid content of the polymer film, namely in a dried state.

Also, it is preferable to set the suction pressure in an increasing series in the downstream direction between the suction devices for the roller sets. This is because the drying proceeds in the downstream direction and a solvent containing amount in the polymer film decreases in the downstream direction. The polymer film gradually comes to have high rigidity, and becomes the more resistant to relatively high suction pressure.

A roller interval G1 between a rear roller and a front roller positioned downstream from the rear roller in each of the roller sets R1-Rn is preferably 1-25 mm, and desirably 2-10 mm. Should the roller interval G1 be more than 25 mm, the polymer film 31 is likely to enter a space between the rear and front rollers typically when pressure of the suction is extremely high, so as to create failure of a surface quality or transporting operation. Should the roller interval G1 be extremely great, it is impossible rapidly to control the pressure of the suction. In contrast, should the roller interval G1 be less than 1 mm, the pressure of the suction is too low so that the polymer film 31 cannot be sucked sufficiently. Consequently, the roller interval G1 can be in the preferable range in the embodiment so as to effect control of the pressure of the suction quickly and also precisely. Even the pressure is remarkably great, the polymer film is prevented from entry between the rear and front rollers. Note that the features of the invention do not depend upon the value of the roller interval G1, which can be set and changed suitably according to the pressure of contact during the transport of the polymer film 31.

In the first roller set R1, the rollers R1a and R1b are the film driving type for directly driving the polymer film. However, it is possible that at least one of the rollers R1a and R1b is the film driving type, in combination with a remaining one of those as a free type driven by the polymer film. The dope 11 comes to have a self-supporting property on the band-shaped support 27, so the polymer film 31 is sucked toward the first roller set R1. Rotation of the rollers R1a and R1b in the roller set R1 strips the polymer film 31 continuously, which is transported toward positions of elements including the second roller set R2. According to the prior art, the polymer film is contacted on the roller R1a and continuously stripped and transported. The polymer film is likely to be damaged with failure in the surface quality typically in the state with a high solvent containing amount. However, the method of the invention can reduce stress applied to the polymer film in winding and transport by the new structure, so that the failure in the surface quality can be prevented. Note that, to supply the polymer film 31 to the tentering device 17, any suitable one roller in the first to nth roller sets R1-Rn can be the film driving type and can transport the polymer film 31.

In the roller sets R1, R2, . . . , Rn, the respective rollers R1a, R1b, R2a, R2b, . . . , Rna and Rnb can be any one of a film driving type for driving and transporting the film, and a free type for being driven by the film, but preferably should be the film driving type. The use of the film driving type makes it possible to determine a difference in the rotational speed between the rear rollers R1a, R2a, . . . , Rna and the front rollers R1b, R2b, . . . , Rnb in the roller sets R1, R2, . . . , Rn. The tensile force applied to the polymer film 31 is controlled in the transporting direction, to control the pressure of contact with the respective rollers.

In the present embodiment, the roller sets R1, R2, . . . , Rn in combination with the suction devices are arranged in the direction of the transport of the polymer film 31, so the suction pressure at each of the roller sets R1, R2, . . . , Rn can be controlled individually. It is possible to control suction pressure at the roller sets R1, R2, . . . , Rn according to the tension of the polymer film 31 in the transporting direction, a curled state of the longitudinal edges of the polymer film 31, and a state or timing of occurrence of streaks and wrinkles.

Also, the speed of transporting the polymer film 31 in the tentering device 17 is preferably 100-120% of a moving speed of the band-shaped support 27. This being so, the polymer film 31 can be stretched in the transporting direction adequately in the transfer section 33.

The rollers R1a, R1b, R2a, R2b, . . . , Rna and Rnb are controlled for the temperature in a manner individual from one another, and are preferably set at a temperature level of 0-60° C. in the present invention. This makes it possible in the transfer section 33 to encourage gasification of the solvent from the polymer film 31 and raise the drying speed of the polymer film 31. Note that each of the rollers R1a, R1b, R2a, R2b, . . . , Rna and Rnb has a jacket structure of a double form, inside which water is circulated. There is one temperature controller or more (not shown) for controlling temperature of the water for the rollers R1a, R1b, R2a, R2b, . . . , Rna and Rnb in a manner individual from one another. Thus, a water entrance (not shown) and a water exit (not shown) are formed in end faces of each of the rollers R1a, R1b, R2a, R2b, . . . , Rna and Rnb. Water is controlled for its temperature by a water temperature controller, and caused to circulate through the water entrance and exit, to control surface temperature of the rollers R1a, R1b, R2a, R2b, . . . , Rna and Rnb at a target level. If one of the rollers R1a, R1b, R2a, R2b, . . . , Rna and Rnb has this jacket structure of a double form, this roller is set as a film driving roller. Note that another heat exchange medium may be used in place of the water for temperature control of the rollers R1a, R1b, R2a, R2b, . . . , Rna and Rnb by circulation. Also, other heating or cooling elements may be used for the temperature control in a direct or indirect manner.

According to the invention, the suction devices S1, S2, . . . , Sn operate for suction while the respective rollers R1a, R1b, R2a, R2b, . . . , Rna and Rnb are heated. Solvent volatilized from the polymer film 31 is withdrawn continuously without remaining near to the surface of the polymer film 31 for considerable time. It is possible to maintain a constant drying speed because density of the gaseous solvent in the vicinity of the polymer film 31 can be regarded as constant. Furthermore, the suction devices S1, S2, . . . , Sn prevent the volatilized solvent from condensation and deposition on the surface of the polymer film 31, because the suction devices withdraw the gaseous solvent continuously.

Also, there is a gas exhausting unit (not shown) connected with the suction devices S1, S2, . . . , Sn. The gasified solvent is cooled and condensed by the gas exhausting unit, and becomes reusable liquid as an ingredient of solvent. In the present embodiment, organic solvent of various kinds is used for a solvent containing amount in the dope. The use of the suction devices S1, S2, . . . , Sn is effective in coping with unwanted influence of the organic solvent not only to human bodies but to the environment.

In the present embodiment, each of the roller sets includes two rollers, and is associated with a suction device. However, each of roller sets may include three or more rollers, which can be combined with one suction device. In such a structure, the three or more rollers should be arranged in such a manner that the polymer film contacts any of the rollers in a flattened form. This is effective in preventing wrinkles, streaks, and various failures in the surface quality of the polymer film.

The above-described methods can be combined with known types of drying methods for the transfer sections. The polymer film and its vicinity in the transfer section is preferably controlled at a temperature in a range from −10° C. to 130° C. For example, a cooling casting process has a step of casting a dope on a cooled support, to obtain gelled cast film, and a step of stripping the cast film. For this process, the cast film and its vicinity can be set at a temperature from −10° C. to 20° C. for ensuring rigidity of the polymer film after stripping. Also, a casting process may have a step of drying the cast film by gasifying the solvent at the periphery of the support, and a step of stripping the cast film. For this process, the cast film and its vicinity can be set at a temperature of 40-130° C. for ensuring rigidity of the polymer film after stripping. Also, drying conditions may be different between sides of the stripped surface 42 and the back surface 40 of the polymer film. If a flow of dry gas is used for drying the polymer film 31, examples of the drying conditions include temperature of the dry gas, a flow rate of the dry gas, a shape, width and other dimensions of nozzles of exiting the dry gas. At least one of those conditions can be changed. It is preferable to set the drying speed higher for the stripped surface 42 than for the back surface 40, because the solvent is contained more in the stripped surface 42 than in the back surface 40 as described above.

In the present embodiment, all of the roller sets R1-Rn are in positions opposed to the stripped surface 42 of the polymer film 31. However, they can be disposed differently. For example, all of the roller sets R1-Rn may be positioned on the side of the back surface 40. Furthermore, the roller sets may include first and second roller set groups, of which the first set group is opposed to the stripped surface 42 and the second set group is opposed to the back surface 40. However, a first roller set R1 included in the plural roller sets can be preferably disposed on the side of the back surface 40. The first roller set R1 in the embodiment comes in contact with the polymer film 31 in a state immediately after being stripped. The polymer film 31 contains solvent at a very high ratio, and has an adhesive property or tacky property. Should the first roller set R1 be caused to contact the stripped surface 42, it is likely that a surface of the polymer film 31 is roughened or the polymer film 31 is broken because the contact of the roller set R1 with the polymer film 31 may be too tight or may result in adhesion. Accordingly, it is preferable to use a stripping roller additional to the roller sets, and to dispose the stripping roller on the side of the back surface 40 reverse to the stripped surface 42.

In the present invention, the rollers R1a, R1b, R2a, R2b, . . . , Rna and Rnb have a regularly cylindrical shape with a constant diameter. However, other types of rollers in a form not cylindrical may be used. For example, rollers may be a convex type, in which a diameter of a middle portion as viewed in a longitudinal direction is greater than end portions. Also, rollers may be a concave type, in which a diameter of a middle portion as viewed in the longitudinal direction is smaller than end portions. Furthermore, a roller of one type can be combined with another roller of a second type to form a roller set, on which one suction device may be provided. Any one of plural roller sets may include two types of rollers. In any manner, the types of the rollers can be determined suitably for various purposes.

For an outer surface of the rollers R1a, R1b, R2a, R2b, . . . , Rna and Rnb, a coating of resin can be preferably applied to a roll. A desirable example of the resin is tetrafluoroethylene or other fluorine resins. The outer surface is subjected to finishing of polish. Note that the scope of the invention is not limited to this structure of the outer surface. Other examples of the coating include metal, ceramic materials, suitable resins, and composite materials. Surface roughness of the outer surface can be determined in a suitable manner. Also, finish of the outer surface can be a selected one of various examples, which include mirror surface finish, mat finish, fine groove finish, and fine pattern finish with patterned recesses or protrusions.

The effects of the invention are specially remarkable when the polymer film 31 is stripped from the band-shaped support 27 at a high speed equal to or more than 45 m/min and equal to or less than 100 m/min. The feature of the invention is effective specially in producing the polymer film 31 having a width equal to or more than 1,400 mm and equal to or less than 1,800 mm. However, the polymer film 31 can have a width more than 1,800 mm with certain good effects. Also, the feature of the invention is effective specially in producing the polymer film 31 having a thickness equal to or more than 15 microns and equal to or less than 100 microns.

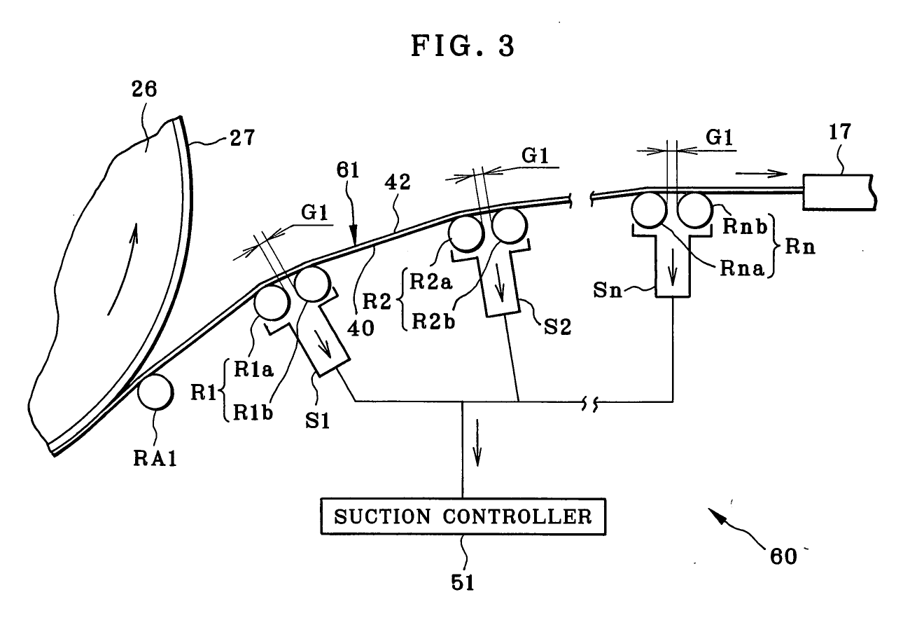

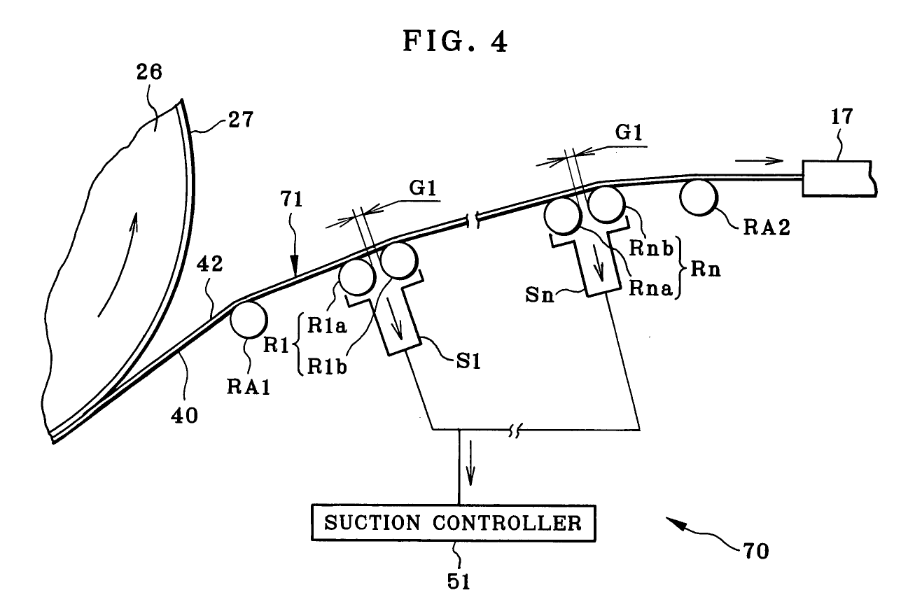

In FIGS. 3 and 4, another preferred embodiment is illustrated. Elements in FIGS. 3 and 4 similar to those in the construction of FIG. 2 are designated with identical reference numerals. A transfer section 60 in FIG. 3 is provided with the roller set R1 in a position shifted downstream from that according to FIG. 2. In addition, a single roller RA1 is provided and positioned upstream from the roller set R1. The roller RA1 operates as a film stripping mechanism. As the roller RA1 is positioned close to the band-shaped support 27 and the most upstream of all the rollers, polymer film 61 with self-supporting properties can be stripped at high speed and can be free from failure in the surface quality and failure in the transport. Probability in occurrence of such failure can be kept very low in the manner similar to the above-described embodiment.

In FIG. 4, a transfer section 70 is illustrated. There is one additional roller RA2 positioned downstream from the roller set Rn and upstream from the tentering device 17. The roller RA1 of FIG. 3 is also used. When polymer film 71 with self-supporting properties reaches the roller RA2, the roller sets R1-Rn keep the polymer film 71 protected from surface failure in the position upstream from the roller RA2.

In the present invention, the transfer section may have two or more structures of rollers including a first structure provided with the suction device and a second structure without the suction device. It is possible to use the suction device only for positions where failure is specifically likely to occur in the transport and the surface quality.

Polymer films producible according to the present invention are cellulose acylate film among polyester films, and desirably cellulose triacetate film. However, films of other materials can be produced. Material for the polymer film may be usable if polymer or precursor of the polymer can be in the form of dope by use of solvent. Examples of the polymers include polyolefins, including polyethylene, polystyrene, polyvinyl chloride, polyviniylidene chloride, polycarbonates, polyamides, and polyimides. If polyimides are used, solution of polyamic acid is cast as precursor of the polyimides, and dried with heat to remove solvent, and then crosslinked to obtain the polyimide film. For cellulose triacetate, there are two examples of which raw materials are different between cotton linter and pulp of wood. The two types may be used singularly, or mixed together.

In the above description, the polymer film has a structure of a single layer. However, polymer film cast by a solution casting apparatus and process of the invention may have a multi-layer structure. To this end, casting may be a successive casting type, a multi-casting type or the like. An example of a die for the multi-casting type is a multi-manifold die.

For the dope of the polymer, various solvents known in the art can be used. Examples of the solvents include halogenated hydrocarbons of various kinds, alcohols, ethers, esters, and ketones, and mixture of at least two of those.

Also, various additives may be contained in the polymer film according to the invention. Examples of the additives generally in use include plasticizers, ultraviolet (UV) absorbers, dyes, optical anisotropic compounds, mat agents and the like.

According to the present invention, it is advantageous to use the polymer film produced by the above method and apparatus for use in a polarizing plate, and a liquid crystal display device.

A polarizing plate of the present invention is constituted by a polarizer of film and two protective films. The polarizer is produced by material of a polyvinyl alcohol (PVA). The protective films are cellulose triacetate film produced by the solution casting of the above embodiment, and are attached to front and rear surfaces of the polarizer as protective films. The polarizer of film is obtained by dyeing the film of polyvinyl alcohols. For dyeing, any one of a method of gas phase adsorption and a method of liquid phase adsorption can be used. In the present embodiment the liquid phase adsorption is used.

Among various examples of substances for dyeing by the liquid phase adsorption, substance of one good example is iodine. Polyvinyl alcohol (PVA) film is dipped in aqueous solution of iodine and potassium iodide (KI) and for dipping time of 30-5,000 seconds. This aqueous solution may contain iodine at a density of 0.1-20 g/l, and potassium iodide (KI) at a density of 1-100 g/l. Also, the aqueous solution is kept at a preferable temperature of 5-50° C. at the time of dipping.

Examples of methods of the liquid phase adsorption may also include application of a coating of iodine solution or other dye solution to polyvinyl alcohol (PVA) film, jetting or spraying of such solution to the polyvinyl alcohol film. However, any suitable known methods of the liquid phase adsorption may be used. In the case of dyeing, operation of dyeing may be before or after stretching the polyvinyl alcohol film. However, the polyvinyl alcohol film has a characteristic of higher stretchability when dyed, because of a suitable wetted state for expansion. Accordingly, it is remarkably preferable to dye the polyvinyl alcohol film before stretching operation.

In place of iodine, two-tone dyestuff can be used preferably for dyeing. Examples of the two-tone dyestuff include dyestuff compounds such as azo compounds, stilbene compounds, pyrazolone compounds, triphenyl methane compounds, quinoline compounds, oxazine compounds, thiazine compounds, and anthraquinone compounds. The best of those examples are water-soluble compounds. Also, molecules of the two-tone dyestuff can preferably contain a hydrophilic functional group, such as a sulfonic acid group, amino group, hydroxide group and the like.

A compound for crosslinking of the polyvinyl alcohol (PVA) is used in producing the polarizer of film by stretching dyed film of polyvinyl alcohol. Specifically, the polyvinyl alcohol film is dipped in solution of crosslinking agent for containing the crosslinking agent in a step before or during the stretching operation. Note that the polymer film may be coated with the solution of the crosslinking agent instead of being dipped therein. The polyvinyl alcohol film is sufficiently hardened owing to the containing of the crosslinking agent. This is effective in having orientation in a suitable manner. The most preferable example of the crosslinking agent is compounds of bromic acid. However, other examples may be used.

Various known adhesive agents can be used for adhesion between the polarizer of film and the cellulose triacetate film as suitable for the purpose of keeping the optical properties. Examples of the adhesive agents include aqueous solutions of polyvinyl alcohol (PVA) polymer containing modified polyvinyl alcohols, and aqueous solutions of compounds of bromine. Examples of such modified polyvinyl alcohols include compounds containing an aceto acetyl group, sulfonic acid group, carboxyl group, and oxy alkylene group. A thickness of the adhesive layer is 0.01-10 microns, and preferably 0.05-5 microns, in a state after being dried. Furthermore, additional layers can be overlaid on the layer of the cellulose triacetate film protecting the polyvinyl alcohol film, the layers including anti-reflection layer, an antiglare layer, a slipping agent layer, and an easy adhesion layer for facilitating tight adhesion.

The anti-reflection film produced according to the present invention can be used preferably in a liquid crystal display device of any of transmission type, reflection type, or semi-transmission type, as the protective film on the one surface of a polarizer. Any of various modes can be used, including Twisted nematic (TN) mode, Super twisted nematic (STN) mode, Vertical alignment (VA) mode, In-plane switching (IPS) mode, Optically compensated bend cell (OCB) mode, and the like. Furthermore, the anti-reflection film is often used in combination with optical compensation films, a phase retardation plate, and the like. Examples of optical compensation films include a wide view film for enlarging a view angle of the liquid crystal display panel. Also, in a liquid crystal display of transmission type or semi-transmission type, the polarizer is used in combination with a popularly marketed brightness enhancement film (polarizing separation film having a selective layer of polarized light, for example, D-BEF (trade name) produced by Sumitomo 3M Ltd.). Thus, the display panel can have properties suitable for easy recognition.

### EXAMPLES

### Example 1

In FIG. 1, the casting apparatus 10 was operated to produce cellulose triacetate film. The dope 11 containing cellulose triacetate and suitable organic solvent was prepared, and cast in such a manner that a width of the polymer film after stripping became 1,550 mm. The moving speed of the band-shaped support 27, which was equal to the stripping speed, was 50 m/min. The transporting speed of the polymer film in the tentering device 17 was at a proportion of 102.5% to the moving speed of the band-shaped support 27.

The transfer section 33 had the three roller sets R1-R3 as depicted in FIG. 2 and having the suction devices S1-S3. The roller R1a in the roller set R1 positioned the most upstream was used for stripping and separating the polymer film. In the roller set R1, the front roller R1b was 2 mm distant from the rear roller R1a. Similarly, in the roller sets R2 and R3, each of the rear rollers R2a and R3a was 2 mm distant from the front roller R2b or R3b. Surfaces of those rollers were coated with fluorine resin, and finished by abrasion or polishing. The rollers being produced were cylindrical and had a constant diameter. The temperature of the rollers was set at 30° C. The pressure of suction was 100 Pa at the roller set R1, 120 Pa at the roller set R2, and 150 Pa at the roller set R3.

The polymer film 31 having passed the transfer section 33 was dried in the tentering device 17 while regulated for its width, and further dried in the dryer 21. Then edge portions of the polymer film 31 were slitted away, before the polymer film 31 was wound. The thickness of the polymer film 31 being dried was 40 microns. The polymer film 31 was evaluated for its failure in the transport in the casting process by human eyes of an operator. Also, the polymer film 31 was inspected by both a camera and human eyes to evaluate folding of edge portions and occurrence of wrinkles.

As a result related to Example 1, there was no failure in the transport. The polymer film 31 had good quality in the surface without occurrence of incidental folding of selvedges or wrinkles or streaks.

### Example 2

This was basically the same as Example 1 but had differences as follows. The roller RA1 of FIG. 3 was added in the transfer section 60 and set upstream from the roller set R1. The roller sets having the suction device were three including R1-R3. The pressure of the suction was 150 Pa for the roller sets R1 and R2, and was 170 Pa for the roller set R3. The transporting speed of the polymer film in the tentering device 17 was at a proportion of 104% to the stripping speed from the band-shaped support 27. The polymer film 61 was formed to have a thickness of 80 microns.

As a result of Example 2, there was no failure in the transport. The polymer film 61 had good quality in the surface without occurrence of incidental folding of selvedges or wrinkles or streaks.

### Example 3

This was basically the same as Example 1 but had differences as follows. The roller RA1 of FIG. 3 was added in the transfer section 60 and set upstream from the roller set R1. The roller sets having the suction device were two, namely R1 and R2. The pressure of the suction was 120 Pa for the roller set R1, and was 150 Pa for the roller set R2. The transporting speed of the polymer film in the tentering device 17 was at a proportion of 102.5% to the stripping speed from the band-shaped support 27. The polymer film 61 was formed to have a thickness of 40 microns.

As a result of Example 3, there was no failure in the transport. The polymer film 61 had good quality in the surface without occurrence of incidental folding of selvedges or wrinkles or streaks.

### Example 4

This was basically the same as Example 1 but had differences as follows. The roller set having the suction device was only R1 of FIG. 4. The roller RA1 was added in the transfer section 70 and set upstream from the roller set R1. The roller RA2 was added in the transfer section 70 to a downstream position. The pressure of the suction was 120 Pa for the roller set R1. The transporting speed of the polymer film 71 in the tentering device 17 was at a proportion of 102.5% to the stripping speed from the band shaped support 27.

As a result of Example 4, there was no failure in the transport. The polymer film 71 had good quality in the surface without occurrence of incidental folding of selvedges or wrinkles or streaks.

### Example 5

This was basically the same as Example 4 but had differences as follows. The pressure of the suction was 150 Pa for the roller set R1 in FIG. 4. The transporting speed of the polymer film 71 in the tentering device 17 was at a proportion of 103% to the stripping speed from the band-shaped support 27. The polymer film 71 was formed to have a thickness of 80 microns.

As a result of Example 5, there was no failure in the transport. The polymer film 71 had good quality in the surface without occurrence of incidental folding of selvedges or wrinkles or streaks.

[Comparison 1]

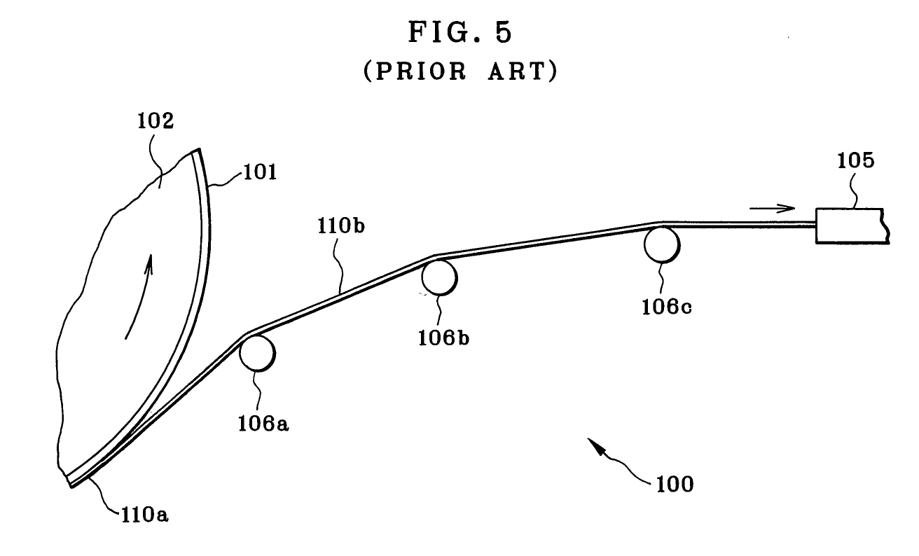

This was basically the same as Example 4 but had differences as follows. In a transfer section 100 of FIG. 5, no suction device was used. No pair of rollers were used. Only three transport rollers 106a, 106b and 106c were used to support and transport polymer film 110b with self-supporting properties. The transporting speed of the polymer film 110b in the tentering device 17 was at a proportion of 102.5% to the stripping speed from the band-shaped support.

Comparison 1 resulted in occurrence in conspicuous wrinkles in the polymer film in the course of the transport. In the polymer film 110b, weakly folded portions or bent portions were found on the selvedges. Wrinkles or streaks occurred, to result in failure in the surface quality.

[Comparison 2]

This was basically the same as Comparison 1 but had differences as follows. The transporting speed of the polymer film 110b in the tentering device 17 was at a proportion of 103% to the stripping speed from the band-shaped support. The polymer film 110b was formed to have a thickness of 80 microns.

Comparison 2 resulted in occurrence in curls in the selvedge in the course of the transport. In the polymer film 110b, folded portions or bent portions were found on the selvedges. Wrinkles or streaks occurred, to result in failure in the surface quality.

It is concluded according to the results of Examples 1-5 and Comparisons 1 and 2 that the suction devices in combination with the transport rollers in the transfer section were able to suppress failure in the transport and failure in the surface quality. This method was specially effective when the polymer film having as small a thickness as 100 microns or less was produced at a transporting speed of 45 m/min or more.

### Example 6

Aqueous solution for dipping was prepared by use of 18.0 g/l of potassium iodide, and kept at 25° C., density of iodine being 0.3 g/l. Polyvinyl alcohol (PVA) film (produced by Kuraray Co., Ltd.), with a thickness of 75 microns, was dipped in the aqueous solution. Then, aqueous solution for stretching was prepared by use of 80 g/l of boric acid and 30 g/l of potassium iodide, and kept at 50° C. The polyvinyl alcohol film was immersed in the aqueous solution, and stretched with a factor of 5.0 times, to obtain a polarizer of film. Samples of cellulose triacetate film from Examples 1-5 were processed in 1.5 N aqueous solution of sodium hydroxide (NaOH) at 50° C. for approximately 180 seconds, and after this, were neutralized and washed with water. The obtained polymer film was attached to each of front and back surfaces of the polarizer of film. An example of the adhesive agent for this purpose was 4% aqueous solution of polyvinyl alcohol PVA-117H (trade name) produced by Kuraray Co., Ltd. Each of the samples was dried in an air thermostatic chamber at 80° C. for approximately 30 minutes, to obtain five (5) types of polarizing plates.

The five polarizing plates were inspected and measured by use of a spectrophotometer, so as to obtain parallel transmittance Yp and crossed transmittance Yc in the visible light region. Then a polarizing coefficient PY was determined from those values according to the following condition.
PY=[(Yp−Yc)/(Yp+Yc)]^{1/2}×100(%)

As a result of Example 6, the polarizing coefficient PY was 99.6% or more and had no unevenness in any of the polarizing plates by use of the films according to Examples 1-5. It was observed that the polymer film obtained by the solution casting process of the invention could be used in a polarizing plate.

### Example 7

The five polarizing plates produced according to Example 6 were utilized as test polarizing plates in combination with an LCD display device. The LCD display device was for a notebook personal computer including TN liquid crystal display of a transmission type, and had originally had a polarizing plate on a display surface. The test polarizing plate was attached on the LCD display device in place of the original polarizing plate. Five LCD display devices were evaluated. Note that the LCD display device included the polarization separation film D-BEF disposed between a backlight and a liquid crystal cell, D-BEF (trade name) being produced by Sumitomo 3M Ltd. and having a polarized light selective layer.

As a result of Example 7, an image displaying operation had no unevenness in the brightness in any of the polarizing plates by use of the films according to Examples 1-5. Very high quality in displaying images was obtained. It is concluded that the polymer film obtained according to the solution casting of the present invention is suitable for the use a liquid crystal display panel.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A solution casting apparatus comprising:
a support for casting of dope containing polymer thereon, whereby polymer film is formed;
plural rotatable rollers for supporting said polymer film stripped from said support;
a tentering device for stretching said polymer film;
wherein said plural rotatable rollers are provided with a suction device for drawing nearer said polymer film by suction.

2. A solution casting apparatus as defined in claim 1, wherein said plural rollers are constituted by at least one roller set each one of which includes at least two rollers;
said suction device effects suction through a space between rollers included in respectively said at least one roller set.

3. A solution casting apparatus as defined in claim 2, wherein said at least one roller set contacts a back surface of said polymer film opposite to a stripped surface thereof stripped from said support.

4. A solution casting process comprising steps of:
casting dope containing polymer on a support, so as to strip polymer film formed of said dope from said support;
transporting said polymer film on rollers, so as to stretch said polymer film in a tentering device;
wherein said plural rollers are constituted by at least one roller set each one of which includes at least two rollers, and are provided with a suction device for suction through a space between rollers included in respectively said roller set; and
drawing nearer said polymer film by suction of said suction device.

5. A solution casting process as defined in claim 4, wherein said roller set comprises plural roller sets to which said polymer film is drawn;
said plural roller sets contact a back surface of said polymer film opposite to a stripped surface thereof stripped from said support.

6. A solution casting process as defined in claim 4, wherein said polymer film is stripped from said support at a speed equal to or more than 45 m/min.

7. A solution casting process as defined in claim 4, wherein said polymer film has a width equal to or more than 1,400 mm and equal or less than 1,800 mm.

8. A solution casting process as defined in claim 4, wherein said polymer film is formed at a thickness equal to or more than 15 microns and equal to or less than 100 microns as viewed when dried.

9. A solution casting process as defined in claim 4, wherein said at least one roller set comprises first to Nth roller sets arranged in a transporting direction of said polymer film;
said plural rollers further include a single rear roller, positioned upstream from said first roller set, opposed to said support, for stripping said polymer film therefrom.

10. A solution casting process as defined in claim 9, wherein said plural rollers further include a single front roller positioned between said Nth roller set and said tentering device.

11. A solution casting process as defined in claim 4, wherein said polymer is cellulose acylate.

12. A cellulose acylate film produced by said solution casting process as defined in claim 11.

13. A polarizing plate including a polarizer, and protective films overlaid on respectively surfaces of said polarizer, wherein:
at least one of said protective films comprises said cellulose acylate film as defined in claim 12.

14. An image display device including said cellulose acylate film as defined in claim 12.
